(19) United States
(12) Patent Application Publication
(10) Pub. No.: US 2025/0070194 A1
(43) Pub. Date: Feb. 27, 2025

(54) METHOD FOR OPERATING A FUEL CELL DEVICE, AND FUEL CELL DEVICE

(71) Applicant: Robert Bosch GmbH, Stuttgart (DE)

(72) Inventor: Helerson Kemmer, Vaihingen (DE)

(21) Appl. No.: 18/724,177

(22) PCT Filed: Jan. 10, 2023
(86) PCT No.: PCT/EP2023/050420

§ 371 Date: Jun. 25, 2024

(30) Foreign Application Priority Data
Jan. 14, 2022 (DE) 10 2022 200 368.3

(51) Int. Cl. H01M 8/04089; H01M 8/04119; H01M 8/04223; H01M 8/04228; H01M 8/04302; H01M 8/0432; H01M 8/0438; H01M 8/0444; H01M 8/04828

(52) U.S. Cl. CPC H01M 8/04097; H01M 8/04179; H01M 8/04228; H01M 8/04253; H01M 8/04302; H01M 8/0432; H01M 8/04388; H01M 8/04447; H01M 8/04828

(57) ABSTRACT

The present invention relates to a method for operating a fuel cell device (10), comprising ensuring (S1) a predetermined hydrogen concentration in an anode circuit of the fuel cell stack (BS); switching off (S4) a hydrogen recirculation in the anode circuit or reducing (S4a) the hydrogen recirculation in the anode circuit to or below a predetermined recirculation volume flow; and drying (SS) a cathode of the fuel cell stack (BS).

### BACKGROUND

The present invention relates to a method for operating a fuel cell device and a fuel cell device.

Known fuel cells can be operated on the basis of hydrogen, wherein these only emit water as exhaust gas and enable fast refueling times, and are therefore considered a mobility concept of the future.

Known fuel cell systems require air and hydrogen for the chemical reaction, wherein the waste heat from the fuel cell stack can usually be dissipated by means of a cooling circuit and released into the environment at the main vehicle radiator. It can be advantageous that the stack can be heated up as quickly as possible when the fuel cell system is started, especially below 0° C. In this respect, rapid heating can ensure that no or almost no water or ice accumulates, which would make it difficult or impossible to continue the start. However, the risk of icing can only be reduced or avoided once the coolant has warmed above 0° C., which can reduce or avoid freezing conditions when the coolant is pumped into the stack.

With such starts under freezing conditions at temperatures below 0° C. according to the usual procedure, the coolant can be heated either outside the stack or by the electrochemical reaction in the stack. In both cases, this can prolong the starting process (e.g., reaching 50% of the load after 30 s at −30° C.). Furthermore, it may be necessary to increase the ice tolerance of the cells (and the system) due to the constant cooling below 0° C. This can be achieved, for example, by installing ice buffers in the cells and heaters in the system.

DE112006003013B4 describes a tank with a fitting and a valve, wherein the valve is fastened in the fitting.

### SUMMARY

The present invention provides a method for operating a fuel cell device according to the disclosure and a fuel cell device according to the disclosure.

Preferred developments are the subject matter of the dependent claims.

The underlying idea of the present invention is to provide a method for operating a fuel cell device and a fuel cell device, wherein an operating strategy for parking a vehicle and thereby reducing internal humidification of a fuel cell stack during the drying process of the fuel cell stack can be achieved.

The method according to the invention and the fuel cell device designed for this purpose can achieve a faster drying process of the fuel cell stack, which can lead to an increase in the energy efficiency of the fuel cell. Comfort behavior can also be achieved in the after-running of the control unit (a fuel cell control unit (FCCU) can have an after-running operation after the vehicle is parked in order to dry out the fuel cell operation), by reducing the duration of unmanned operation of components after the vehicle is parked with the associated noise level.

Furthermore, the reliability of the drying of the cells can be increased, which can lead to a safer and more robust start under freezing conditions, especially in extreme outdoor conditions (low temperatures).

Furthermore, a reduction in the costs of the fuel cell system can be achieved because, for example, ice buffer measures in the stack and system can be dispensed with or this expense can be significantly reduced.

Furthermore, an increase in the service life of the stack can be achieved by reducing the duration of the drying process with an associated reduction in the local drying out of the membrane and prevention or reduction of cell freezing, which can lead to irreversible damage during a start under freezing conditions.

According to the invention, the method comprises ensuring a predetermined hydrogen concentration in an anode circuit of the fuel cell stack; switching off a hydrogen recirculation in the anode circuit, or reducing the hydrogen recirculation in the anode circuit to or below a predetermined recirculation volume flow; and drying a cathode of the fuel cell stack.

According to the method, the hydrogen concentration can be increased, e.g., by a longer purge process, in order to operate a fuel cell device. This can be ensured with a purge process, wherein the hydrogen in the anode circuit can be exchanged and attention can be paid to the amount of hydrogen discharged or introduced and thus the pressure ratios and/or hydrogen concentration in the anode circuit after the purge process can be inferred. If it is possible to measure a hydrogen concentration, the hydrogen concentration determined is compared with a default value or default interval for the hydrogen concentration and the hydrogen concentration in the anode circuit is equalized at least to the default value or to the default interval during this increase/ensuring; a hydrogen recirculation in the anode circuit is switched off or the hydrogen recirculation in the anode circuit is reduced to or below a predetermined recirculation volume flow; and a cathode of the fuel cell stack is dried.

The default value or the default interval can be specified by a manufacturer or a user of the fuel cell stack and stored in the control unit or can be received by the latter and set in such a way that an expected mode of operation and a desired functional framework for the operation of the fuel cell stack can be achieved while complying with this default value or default interval. The hydrogen concentration can be equalized by valves for draining or admitting the hydrogen into the anode circuit, for example from a hydrogen supply or to a hydrogen drain.

The cathode is dried by an air flow through the stack with clearly overstoichiometric conditions.

The predetermined recirculation volume flow can correspond to such a recirculation volume flow in the anode circuit as is necessary for a usual or average or desired mode of operation/performance of the fuel cell stack, and is selected by the manufacturer or user and can be stored in the control unit in this way or can be received by it.

A correspondingly effective drying process during the parking phase of the vehicle can be decisive. The shutdown phase concerns the cessation of vehicle operation and a subsequent standstill period of the vehicle and the drive and a subsequent start phase after a longer period of time, for example at low outside temperatures.

According to a preferred embodiment of the method, for ensuring, the hydrogen concentration is compared with a default value or default interval for the hydrogen concentration and the hydrogen concentration in the anode circuit is equalized at least to the default value or to the default interval.

According to a preferred embodiment of the method, a necessity for drying the cathode of the fuel cell stack of the fuel cell device is recognized and an operating mode of the fuel cell stack is subsequently adopted with the drying. This can be triggered, for example, by prevailing or expected environment temperatures below 0° C.

The operating mode of the fuel cell stack for drying may involve drying at the cathode according to the invention with a monitoring method (looping method) for recirculating and/or supplying hydrogen in the anode circuit.

According to a preferred embodiment of the method, before the fuel cell process is switched off, it is determined via an environmental control device whether the cathode of the fuel cell stack is to be dried and/or a command is received from a user that the cathode of the fuel cell stack is to be dried.

According to a preferred embodiment of the method, after the fuel cell stack has stopped operating with drying, the fuel cell stack is started under freezing conditions.

The start under freezing conditions corresponds to starting the operation of the fuel cell stack (the necessary supply of the reaction gases and the operation of the necessary components/parts) at or below 0° C. in the vehicle's environment.

According to a preferred embodiment of the method, after switching off or reducing the hydrogen recirculation or for reducing the hydrogen recirculation, a hydrogen supply to the anode circuit is switched off or the hydrogen supply to the anode circuit is reduced to or below a predetermined supply volume flow.

According to a preferred embodiment of the method, after switching off or reducing the hydrogen supply, an anode pressure of the hydrogen in the anode circuit at the anode is monitored until it reaches or falls below a lower default value for the anode pressure and subsequently it is determined whether the drying is completed, and if it is determined that the drying is completed, subsequently the drying is terminated.

According to a preferred embodiment of the method, when it is determined that drying is not yet complete, the hydrogen supply is switched back on or increased and then the anode pressure is monitored until the anode pressure exceeds or reaches an upper default value for the anode pressure and subsequently the hydrogen circulation is reduced or switched off again and the hydrogen supply is reduced or switched off and the anode pressure is monitored, until the anode pressure falls below or reaches the lower default value for the anode pressure and it is subsequently determined again whether drying is complete, and if it is determined that drying is complete, drying is subsequently stopped and if it is determined that drying is not yet complete, the hydrogen supply is increased again or switched on and the regulation of the anode pressure between the upper and lower default value is repeated until drying is complete.

The method can be in a looping process as long as the drying has not yet been completed, in other words, as long as a corresponding parameter for drying has not yet reached or exceeded/fallen below its target value. According to the invention, the anode pressure can be regulated between the upper and lower default values while controlling the recirculation and/or supply of hydrogen. For example, operation can be time-controlled to detect whether drying has not yet been completed, wherein operation can be interrupted after a certain drying time and it can be checked whether the next start under freezing conditions is successful. On the other hand, a measurement of the cathode or anode outlet moisture, a visual observation of the water in the exhaust, impedance of the membrane, or other factors can be carried out and the degree of drying can be inferred.

According to a preferred embodiment of the method, the hydrogen recirculation is also increased or switched on immediately after the hydrogen supply is increased or switched on.

In the looping process, the hydrogen recirculation can also be increased or switched on each time the hydrogen supply is increased or switched on. This can be particularly useful for systems with passive or partially passive hydrogen recirculation, as the recirculation can be maintained as long as the hydrogen supply can remain switched on.

According to a preferred embodiment of the method, the hydrogen supply and/or hydrogen circulation is reduced and/or increased according to a sawtooth pattern. This allows the advantage of the method to be combined with the possibility of discharging water from the anode circuit in phases with high hydrogen circulation, for example.

According to the invention, the fuel cell device comprises a fuel cell stack having an anode and a cathode; a hydrogen recirculation circuit at the anode; a hydrogen supply connected to the anode and/or to the hydrogen recirculation circuit; a water drain at the cathode; a control unit connected to the hydrogen supply and/or to the hydrogen recirculation circuit and/or to the water drain and set up to perform a method according to the invention.

According to a preferred embodiment of the fuel cell device, this comprises a pressure sensor on the anode, with which an anode pressure can be determined by the control unit and the anode pressure can be compared with an upper default value and/or with a lower default value for the anode pressure.

The fuel cell device may also be characterized by the features and advantages mentioned in connection with the method and vice versa.

### BRIEF DESCRIPTION OF THE DRAWINGS

Further features and advantages of embodiments of the invention arise from the following description with reference to the accompanying drawings.

The present invention is explained in greater detail below with reference to the exemplary embodiments indicated in the schematic figures of the drawings.

Shown are:

FIG. 1 a schematic representation of a fuel cell device according to an exemplary embodiment of the present invention;

FIG. 2 a schematic representation of a course of the method according to an exemplary embodiment of the present invention;

FIG. 3 a block diagram of method steps of the method for operating a fuel cell device according to an exemplary embodiment of the present invention.

### DETAILED DESCRIPTION

In the figures, identical reference signs denote identical or functionally identical elements.

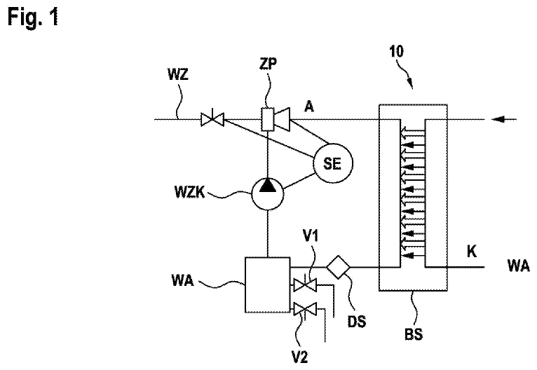

FIG. 1 shows a schematic representation of a fuel cell device according to an exemplary embodiment of the present invention.

The fuel cell device 10 comprises a fuel cell stack BS with an anode A and a cathode K; a hydrogen recirculation circuit WZK at the anode A; a hydrogen supply WZ, which is connected to the anode and/or to the hydrogen recirculation circuit WZK; a water drain WA at the cathode K; a control unit SE, which is connected to the hydrogen supply WZ (for example a valve for the hydrogen supply) and/or to the hydrogen recirculation circuit WZK and/or to the water drain WA for draining water and thus for drying the cathode and is set up to carry out a method according to the invention and to control the components concerned in such a way. The fuel cell device 10 can comprise a pressure sensor DS on the anode A, with which an anode pressure can be determined by the control unit, the anode pressure can be determined with an upper default value and/or with a lower default value for the anode pressure. The control unit SE can also be connected to other valves, sensors, and pumps in the fuel cell system.

A component of the water drain WA can also be present on the anode side in the hydrogen recirculation circuit WZK; for this purpose, a water separator on the anode side can comprise a first valve V1 for hydrogen and a second valve V2 (each for draining) for water or several valves. The hydrogen supply can be connected to a circulation pump ZP.

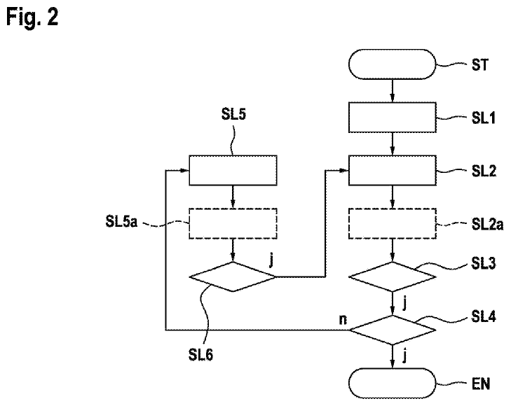

FIG. 2 shows a schematic representation of a course of the method according to an exemplary embodiment of the present invention.

FIG. 2 shows a looping method, wherein the method according to the invention can be carried out according to such a looping form or a similar looping form.

According to the method of FIG. 2, the drying process of the fuel cells can generally be divided into several operating and method steps between switching on (starting) the drying ST and ending the drying EN, before the vehicle is parked and before the fuel cell operation is stopped. The end of drying EN can be reached when a predetermined degree of moisture has been removed from the cells and/or the exhaust gas on the cathode side or when the residual moisture content on the cathode side has fallen below a predetermined tolerable residual moisture value or residual water content.

Before the fuel cell process is switched off or on, it can be determined via an environmental control device (sensor, interface with a user or an optical or electronic monitoring device) whether the cathode of the fuel cell stack is to be dried and/or a command is received from a user that the cathode of the fuel cell stack is to be dried. This can be done advantageously in conjunction with knowledge of an imminent longer service life of the vehicle when the fuel cell system is switched off. After such a drying process, a start under freezing conditions of the fuel cell stack can take place after the operation of the fuel cell stack has been stopped.

First, a hydrogen concentration can be ensured (S1) in an anode circuit (for example in the feed and recirculation run to the anode) of the fuel cell stack and then or in the process a comparison (S2) of the determined hydrogen concentration with a default value or default interval for the hydrogen concentration and an equalization (S3) of the hydrogen concentration in the anode circuit at least to the default value or into the default interval can take place and the hydrogen concentration in this default value or default interval can be raised, lowered, or maintained. This step can advantageously represent the provision SL1 of the necessary hydrogen concentration in the anode circuit, which may be necessary for a drying process and/or for operating the fuel cell.

In a subsequent step SL2, hydrogen recirculation in the anode circuit can be switched off or reduced (S4, S4a) to or below a predetermined recirculation volume flow.

In a further subsequent optional step SL2a, a hydrogen supply to the anode circuit can now be switched off or the hydrogen supply to the anode circuit can be reduced to or below a predetermined supply volume flow.

In a further subsequent step SL3, after switching off or reducing the hydrogen supply, or if the step SL2a of switching off the hydrogen supply did not take place and only a reduction or switching off of the recirculation took place, an anode pressure of the hydrogen in the anode circuit at the anode can be monitored until this reaches or falls below a lower default value for the anode pressure and, if the anode pressure is in this value range, subsequently determined in a next step SL4 whether drying is complete, and if it is determined that drying is complete (condition j), drying is subsequently ended in step EN, and if it is determined that drying is not yet complete (condition n), the hydrogen supply is switched on again or increased in the subsequent step SL5 and then, optionally, the hydrogen recirculation can be switched on or increased in the next step SL5a.

After increasing or switching on the hydrogen supply or optionally switching on or increasing the recirculation in step SL5a, the anode pressure can be monitored in a subsequent step SL6, until the anode pressure exceeds or reaches an upper default value for the anode pressure and then step SL2 is carried out again and the hydrogen circulation is reduced or switched off again and the aforementioned steps SL2 to SL4 can be repeated and, if the drying process is completed after step SL4, the drying in EN can be ended or otherwise the loop with steps SL5 to SL6 can be carried out again and the recirculation can be switched off or reduced again with step SL2 and the subsequent loop.

Accordingly, after the drying process is started, it can first be ensured that a sufficiently high hydrogen concentration prevails in the anode circuit, which can be achieved by a sufficient introduction of hydrogen and/or a so-called extensive “purging” and a corresponding measurement of the hydrogen concentration. Subsequently, the recirculation can be switched off, for example by switching off the recirculation fan or greatly reducing it. As a result, the internal humidification of the cells can be switched off or greatly reduced and water can be efficiently removed from the cells by drying the cathode. An additional, optional measure can be to switch off or reduce the hydrogen supply. This is particularly useful for systems with passive or partially passive hydrogen recirculation, as the recirculation can be maintained as long as the hydrogen supply remains switched on.

If the hydrogen supply is switched off completely and the anode pressure falls below or reaches a certain threshold, for example the lower default value of 1.1 bars, and the drying process has not yet been completed, the hydrogen supply can be switched on again or increased, or optionally the hydrogen recirculation can be increased again. These measures may be necessary to ensure that there is no hydrogen depletion and thus cell degradation or that the risk of this is at least reduced. If the anode pressure rises above or reaches a threshold, i.e., the upper default value of e.g., 1.4 bars, the hydrogen recirculation or supply can be switched off again. This regulation can also ensure that the pressure differences to the cathode cannot become too high (e.g., over 0.5 bars) or at least reduce the risk of this happening.

As an alternative to this operating strategy, switching the hydrogen recirculation or supply on and off during the loop or independently of it can be time-based. It can also be controlled by means of direct or indirect detection of the hydrogen concentration in the anode circuit. Furthermore, the reduction or increase in hydrogen recirculation or supply can be sawtooth-like.

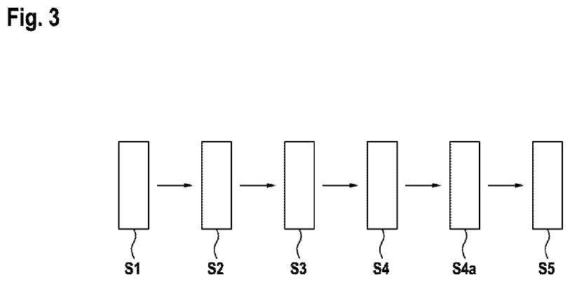

FIG. 3 shows a block diagram of method steps of the method for operating a fuel cell device according to an exemplary embodiment of the present invention.

The method of operating a fuel cell device comprises ensuring S1 a predetermined hydrogen concentration in an anode circuit of the fuel cell stack; switching off S4 of a hydrogen recirculation in the anode circuit or reducing S4a the hydrogen recirculation in the anode circuit to or below a predetermined recirculation flow rate; and drying S5 a cathode of the fuel cell stack. To ensure S1, the hydrogen concentration can be compared S2 with a default value or default interval for the hydrogen concentration and the hydrogen concentration in the anode circuit can be equalized S3 at least to the default value or to the default interval.

Although the present invention has been completely described hereinabove with reference to the preferential exemplary embodiment, it is not limited thereto and can be modified in a variety of ways.

1. A method of operating a fuel cell device (10) comprising the steps of:
ensuring (S1) a predetermined hydrogen concentration in an anode circuit of the fuel cell stack (BS);
switching off (S4) a hydrogen recirculation in the anode circuit or reducing (S4a) the hydrogen recirculation in the anode circuit to or below a predetermined recirculation volume flow; and
drying (S5) of a cathode of the fuel cell stack (BS).

2. The method according to claim 1, wherein ensuring (S1) ensuring (S1) a predetermined hydrogen concentration in an anode circuit of the fuel cell stack (BS) includes comparing (S2) the hydrogen concentration is compared with a default value (VW) or default interval for the hydrogen concentration (WK) and/or equalizing (S3) the hydrogen concentration in the anode circuit at least to the default value (VW) or to the default interval.

3. The method according to claim 1, in which, before the fuel cell process is switched off or switched on, it is determined via an environmental control device whether the drying of the cathode of the fuel cell stack is to take place and/or a command is received from a user that the drying of the cathode of the fuel cell stack is to take place.

4. The method according to claim 1, wherein after the fuel cell stack (BS) has stopped operating with drying, the fuel cell stack is started under freezing conditions.

5. The method according to claim 1, wherein after switching off or reducing the hydrogen recirculation or for reducing the hydrogen recirculation, a hydrogen supply to the anode circuit is switched off or the hydrogen supply to the anode circuit is reduced to or below a predetermined supply volume flow.

6. The method according to claim 5, in which, after switching off or reducing the hydrogen supply, an anode pressure of the hydrogen in the anode circuit at the anode is monitored until it reaches or falls below a lower default value for the anode pressure and it is subsequently determined whether drying has been completed, and if it is determined that drying has been completed, drying is subsequently terminated.

7. The method according to claim 5, in which, when it is determined that drying is not yet complete, the hydrogen supply is switched on or increased again and then the anode pressure is monitored until the anode pressure exceeds or reaches an upper default value for the anode pressure and subsequently the hydrogen circulation is reduced or switched off again and the hydrogen supply is reduced or switched off and the anode pressure is monitored, until the anode pressure falls below or reaches the lower default value for the anode pressure and it is subsequently determined again whether drying is complete, and if it is determined that drying is complete, drying is subsequently stopped and if it is determined that drying is not yet complete, the hydrogen supply is increased again or switched on and the regulation of the anode pressure between the upper and lower default value is repeated until drying is complete.

8. The method according to claim 7, in which, immediately after the hydrogen supply is increased or switched on, the hydrogen recirculation is also increased or switched on.

9. The method according to claim 5, in which a reduction and/or increase of the hydrogen supply and/or the hydrogen circulation takes place according to a sawtooth pattern.

10. A fuel cell device (10) comprising:
a fuel cell stack (BS) with an anode (A) and a cathode (K);
a hydrogen recirculation circuit (HCC) at the anode (A);
a hydrogen supply (WZ), which is connected to the anode and/or to the hydrogen recirculation circuit (WZK);
a water drain (WA) at the cathode (K);
a control unit (SE) which is connected to the hydrogen supply (WZ) and/or to the hydrogen recirculation circuit (WZK) and/or to the water drain (WA) and is configured to
ensure (S1) a predetermined hydrogen concentration in an anode circuit of the fuel cell stack (BS);
switch off (S4) a hydrogen recirculation in the anode circuit or reducing (S4a) the hydrogen recirculation in the anode circuit to or below a predetermined recirculation volume flow; and
dry (S5) of a cathode of the fuel cell stack (BS).

11. The fuel cell device (10) according to claim 10, which comprises a pressure sensor on the anode (A), with which an anode pressure can be determined by the control unit and the anode pressure can be compared with an upper default value and/or with a lower default value for the anode pressure.
